(19) United States
(12) Patent Application Publication
(10) Pub. No.: US 2010/0059091 A1
(43) Pub. Date: Mar. 11, 2010

(54) INDUSTRIAL CLEANING SYSTEM

(76) Inventor: Werner Meissner, Marienheide (DE)

Correspondence Address: KRIEGSMAN & KRIEGSMAN, 30 TURNPIKE ROAD, SUITE 9, SOUTHBOROUGH, MA, 01772, US

(21) Appl. No.: 12/449,013

(22) PCT Filed: Jan. 18, 2007
(86) PCT No.: PCT/DE2007/000100

§ 371 Date: Jul. 20, 2009

(51) Int. Cl. B08B 3/10

(52) U.S. Cl. 134/108

(57) ABSTRACT

The invention relates to an industrial washing plant with at least one treatment chamber for washing objects that are dirtied with oily, greasy, or other processing residues and are treated with treatment media that require process heat for heating active washing fluids, rinsing fluids, for example, pure water or air for drying in an air flow, in order to improve the treatment result. A washing-fluid tank and a rinsing-fluid tank can be provided, and these tanks will supply the treatment chambers by means of electrical devices. Further, nearly pure fluid can be recovered from used washing fluid or rinsing fluid by distillation by means of an evaporator and re-introduced into a treatment medium. The object of the invention consists of creating an industrial washing plant that is designed in such a way that its overall operation leads to an improvement of economical and ecological balances. The object is accomplished by integrating a power/heat coupling plant into the process-heat circuit of the washing plant, in that its process-heat component takes care of the process-heat requirement of the plant and can be introduced for heating the treatment media, and in that the electrical power or current component of the power/heat coupling plant takes care of the power or current requirement of the electrical/electronic installations.

The invention relates to an industrial washing plant with at least one treatment chamber for washing objects that are dirtied with oily, greasy, or other processing residues and are cleaned or washed with treatment media that require process heat for improving the treatment result, e.g., for heating active washing fluids, rinsing fluids, for example, pure water or air for drying in an air flow.

Such a washing plant is known from DE 42 08 665 A1. The known plant has a treatment chamber, in which there takes place sequentially a washing process, a rinsing process and a drying process with a washing circuit, a rinsing circuit and a drying circuit, or in which the washing, the rinsing and the drying each take place in separate treatment chambers, wherein the washing circuit is supplied from an alkali tank that contains an aqueous washing fluid mixed with an active substance for washing, and the rinsing circuit is supplied from a rinsing tank that contains fresh water, wherein used washing and/or rinsing fluids are subjected to filtering or recovered by means of an evaporator and a heat-exchanger circuit and are again introduced into the alkali tank or rinsing tank, wherein the off-heat of the heat-exchanger circuit is utilized for the purpose of heating the washing fluid and/or rinsing fluid or the air flow for drying.

An electrically operated heating device in the alkali tank is necessary for operating the washing circuit of the known plant in order to bring the washing fluid to operating temperature.

Electrical motors, electrically actuated pumps of different structural types, such as low-pressure or high-pressure pumps, and electrically actuated valves and stop valves as well as electrical/electronic measurement, control, regulating, monitoring devices are provided in the washing circuit for measuring, controlling, regulating and monitoring the washing cycle. The treatment chamber is moved, rotated or pivoted with this electrical equipment, or the objects in the treatment chamber are moved, i.e., rotated or pivoted by means of an electrical drive. It is further provided for this that the heated washing fluid is conveyed to the treatment chamber in a correct timing cycle, that it remains there for the duration of treatment and that it is again pumped out after the treatment and conveyed for further processing, such as filtering or distillation, all of this conducted with the named electrical equipment.

In order to operate the rinsing circuit of the known plant, a similar outlay is necessary, for rinsing off the active washing residues that still adhere to the washed parts by means of the heated rinsing fluid. For this purpose, an electrical heating device is installed in the rinsing tank, whereby the rinsing fluid is provided and controlled with a rinsing circuit constructed similarly to the washing circuit.

In order to operate drying in the heated air flow, in addition to the electrically operated air heaters, additional electrical units, such as compressors and ventilators, are also necessary. The recovery of the heat energy from the off-heat by distillation takes care of only a portion of the energy necessary for operating the washing plant.

In summary, it is established that the electrical power used for operating such a washing plant is consumed for the most part for heating the process media, such as water, hydrocarbons, air, etc., and to a lesser extent for operating the electromechanical units such as pumps, motors, valves, compressors, ventilators, and electrical and electronic controls for the plant.

The economic balance of such a plant operated with electrical power is based on the current electrical power or current prices as well as the fossil fuels that are available, such as coal, gas and oil. Considered in economic terms, each kilowatt hour of power from the grid of a conventional power plant loads the environment by discharging a certain quantity of CO₂.

As an alternative to only inputting of electrical power, a separate utilization of electrical power or current that is separate from the grid by means of gas or oil is conceivable for the operation of electromechanical units and the electrical and electronic controls of the plant as well as for the generation of process heat. Economically and ecologically, a certain utilization of these alternatives against only inputting electrical power is established, but an external connection for electricity is still necessary for the operation of the plant.

Systems which make possible a simultaneous production of mechanical energy with direct transformation into electricity and useful process heat are known for coupling power and heat. Thus, electrical power or current and heat are obtained simultaneously, but the heat requirement always determines the overall process. The advantage of coupling power and heat is the high utilization of the primary energy supplied, of up to 85% utilization ratio.

DE 295 044 64 U1 describes a plant for processing old wood for the production of homogeneous combustion material for rotary furnaces in the cement industry. A unit is provided for the generation of driving energy for the mechanical devices of the plant, and this unit is driven by means of an internal combustion engine. A dryer, which is heated with the exhaust gases of the internal combustion engine, is present in order to dry the crushed old wood. Additionally, the cooling water of the internal combustion engine can be used for heating. A block-type thermal power station is used for the structural design of the plant.

DE 100 39 495 A1 describes an offset printing plant with a drying device for drying freshly printed paper webs. A coupling of power and heat is provided. In this case, the hot exhaust gases of an internal combustion engine are guided through a heat exchanger to the heating device of the drying system. The cooling circuit of the internal combustion engine serves for heating the building in which the plant is located. Another cooling circuit serves for operating a refrigerating unit.

The object of the invention consists of creating an industrial cleaning or washing plant, which is designed in such a way that its overall operation leads to an improvement in economical and ecological balances.

The object is accomplished according to the invention by the measures listed in claim 1. Enhancements of the invention are described in the subclaims.

The invention involves a combination of two plants, one of which, here the washing plant, consumes process heat and electrical power for operation, and the other of which generates the required process heat and electrical power, by the utilization of primary energy, such as gas or petroleum, in this case designed as a plant for the coupling of power and heat.

An advantage of the invention consists of the fact that the producer and consumer of process heat and electrical energy can be combined into a compact structural unit. Particularly in regions with a sparsely constructed infrastructure of the electrical grid, this combination plant can be operated automatically, i.e., independently of the grid, wherein the primary energy such as gas or oil that is used is optimally utilized. The combination plant can be operated very economically due to the high utilization ratio of the primary energy that is utilized. The ecological balance is particularly interesting. For small to intermediate-size plants, the CO₂ emission is calculated at up to 5 to 8 kg/hour. In the case of an annual operating time of approximately 5000 hours for the combination plant, there results an effective savings of 35 t annually to 40 t annually.

Taken individually, the cooling circuit of the power/heat coupling plant and the heating circuit of the washing plant are combined in such a way that the process heat for the process media of the washing plant is produced by the power/heat coupling plant. The process heat of the power/heat coupling plant can be delivered to the process media of the washing plant via heat exchangers which are advantageously built into the washing-fluid tank and/or the rinsing-fluid tank in the case of a single-chamber washing plant. In the case of multi-chamber plants, the heat exchangers can be incorporated into the respective treatment chambers.

Power/heat coupling plants operate particularly economically with approximately 70% heat production and 30% generation of electrical power or current. It is advantageous for the power/heat coupling plant to fine-tune the diversion of the energy requirement for the production of process heat and the generation relative of electricity [needed] to process heat and electricity for the washing plant.

In the start-up phase of the washing process, thus when the plant is started up, if heat is predominantly required, the power that is produced can be used for the purpose of contributing to the production of process heat by means of electrical heating units. For this purpose, the electrical heating units are advantageously designed as immersion heating units and are incorporated into the corresponding washing-fluid tank or rinsing-fluid tank. In this way, a nearly 100% utilization of the power generated is achieved. With the heat arising during the generation of electrical power, the cooling circuit of the power/heat coupling plant directly heats the process media or does so in parallel via heat exchangers. The electrical power of the power/heat coupling plant is required by the electrical units, such as pumps and compressors, in the operation of the plant. The heat from the cooling cycle of the power/heat coupling plant is utilized in order to keep the process media at the operating temperature. The utilization of the components for process heat can be controlled by means of an electrical or electronic control.

The power/heat coupling plant is advantageously designed as a block-type thermal power station with a liquid-cooled internal combustion engine. Water, hydrocarbon or heating oil can be used as the cooling fluid. The operating temperature of a washing plant with an aqueous washing fluid lies between 50° C. and 90° C. In closed process-heat circuits, the operating temperature can amount to more than 100° C. In order to avoid separate heat exchangers in the circuits, the cooling fluid of the internal combustion engine can be used as the washing fluid or the rinsing fluid and can be guided correspondingly through the washing or rinsing tank.

Two embodiment examples of the invention will be described in more detail below on the basis of block diagrams.

Herein is shown:

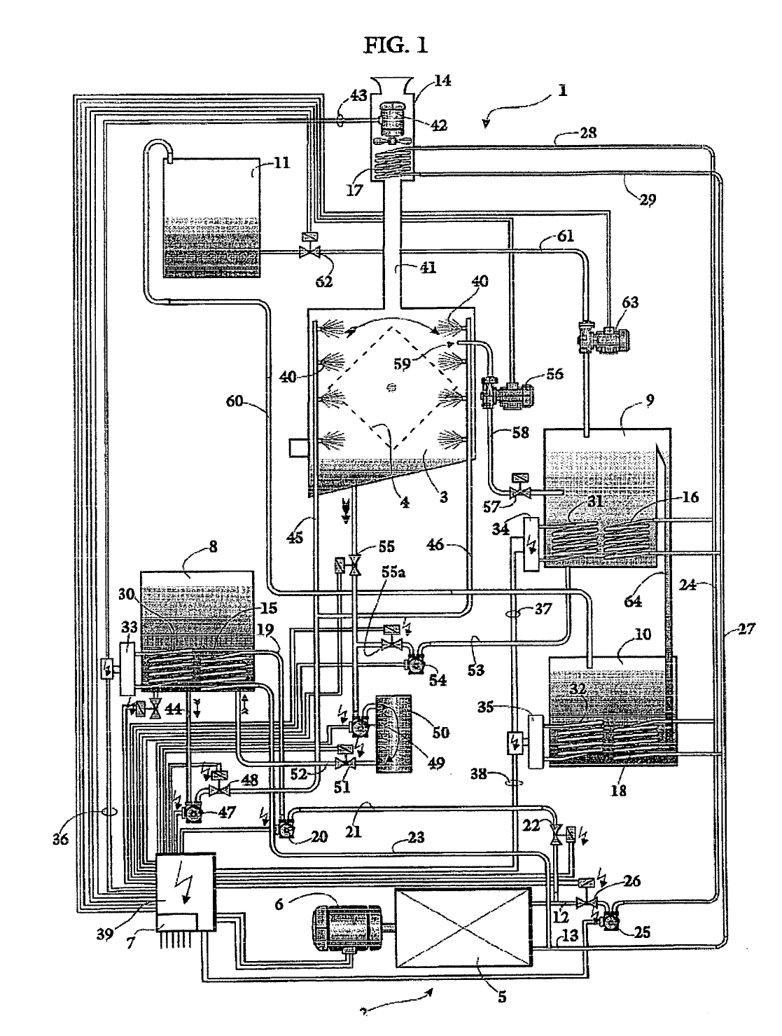

FIG. 1: A single-chamber design of the washing plant;

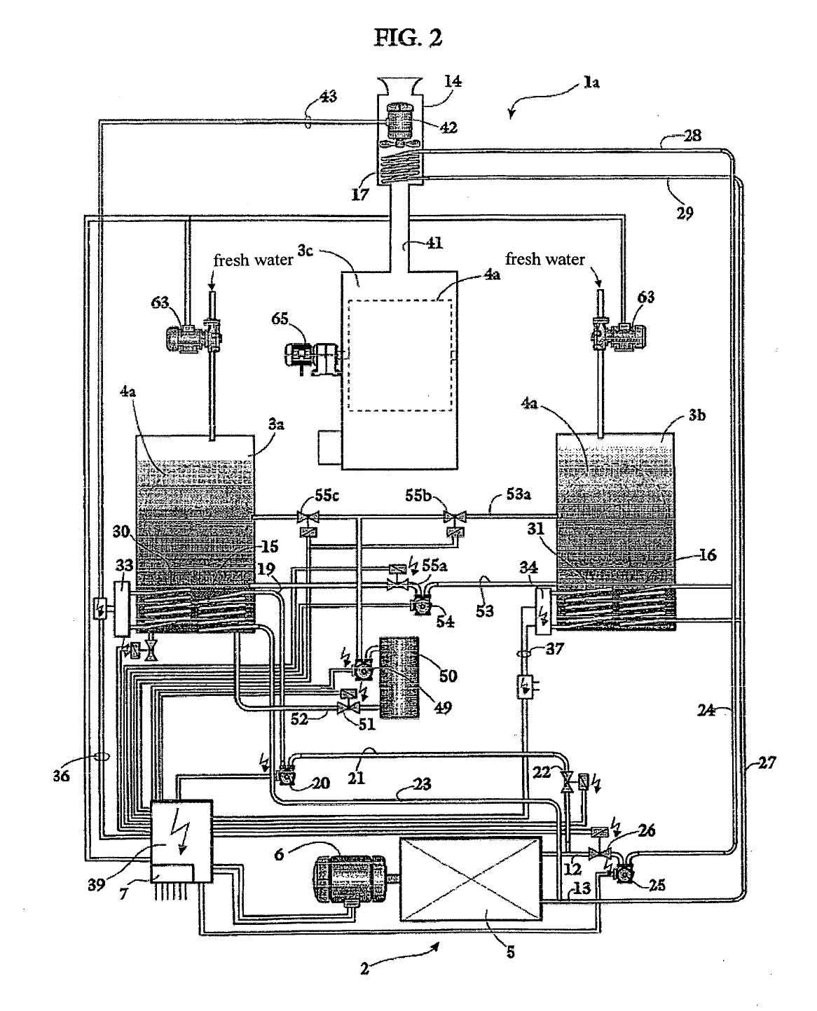

FIG. 2: A washing plant with three treatment chambers.

The embodiment of the invention according to FIG. 1 involves the combination of a washing plant 1 with a power/heat coupling plant 2. The washing plant 1 involves a one-chamber design with only one treatment chamber 3, in which the objects or parts (not shown here) are sequentially washed, rinsed and dried by means of a rotatable or pivotable support 4. The power/heat coupling plant 2 is comprised of an internal combustion engine 5 and a generator 6. The power/heat coupling plant 2 is designed as a block-type thermal power station and is integrated into the plant circuit of washing plant 1. Gas or diesel fuel serves as primary energy for the internal combustion engine 5. The process heat is produced with power/heat coupling plant 2 for the process media, such as washing fluid, rinsing fluid and hot air for drying, and electrical current or power for operating the electrical units, such as pumps, valves, as well as the overall electrical and electronic control device 7.

The embodiment of the invention according to FIG. 2 involves a washing plant 1a, which has several treatment chambers, i.e., a washing chamber 3a, a rinsing chamber 3b and a drying chamber 3c, in which the parts are sequentially placed and washed, rinsed or dried. Tub-like tanks are involved in this case, in which the parts to be cleaned are immersed and rotated or pivoted for purposes of treatment.

The washing plant 1 according to FIG. 1, in addition to treatment chamber 3, has a washing-agent tank 8, a rinsing-fluid tank 9, an evaporator 10, as well as a collecting tank 11 for the distillate produced in evaporator 10.

The structure and function of a power/heat coupling plant are sufficiently known, so that a detailed description of power/heat coupling plant 2 that is used can be omitted. It is important that the entire off-heat of internal combustion engine 5, thus even the exhaust gases, can be utilized for the generation of process heat. A pipeline system with a primary branch 12 and a secondary branch 13 serves for further conducting the process heat to washing plant 1, 1a. The latter involves a closed heat circuit. Heating oil or hydrocarbons preferably are used for transferring the process heat from internal combustion engine 5 to washing-agent tank 8, rinsing-fluid tank 9, or washing chamber 3a, rinsing chamber 3b and air heater 14, as well as to evaporator 10. Process temperatures of up to and over 100° C. can be obtained for washing plant 1 with these transfer media, so that even evaporator 10 can be operated largely by process heat and additional primary energy may only need to be used in the upper temperature range.

The process heat is delivered to the washing fluid, rinsing fluid or drying air as well as to the evaporator medium, in this case, used washing fluid or rinsing fluid, via heat exchangers 15, 16, 17, 18, which are incorporated in washing-agent tank 8 or washing chamber 3a, rinsing-fluid tank 9 or rinsing chamber 3b, air heater 14 as well as evaporator 10. Heat exchanger 15 is connected on the primary side to primary branch 12 via lines 19, 21, a pump 20 and an electrical valve 22, while on the secondary side it is connected to secondary branch 13 via a line 23. Heat exchanger 16 is connected on the primary side to primary branch 12 via line 24, pump 25 and valve 26. It is connected to secondary branch 13 via a line 27. The same connections are made for heat exchanger 18 in evaporator 10, wherein it may be necessary to connect this heat exchanger 18 separately or via a bypass to the primary branch 12 and the secondary branch 13, in order to be able to individually control each individual heat exchanger 15, 16, 18. The same holds true also for heat exchanger 17 in air heater 14, which is connected here on the primary side to primary branch 12 via lines 28, 24 and pump 25 and valve 26. On the secondary side, the connection is made to secondary branch 13 via lines 29, 27.

In the embodiment examples of the invention, in addition to heat exchangers 15, 16 and 18, electrical heating devices 30, 31, 32 are incorporated in washing-agent tank 8 or in washing chamber 3a, in rinsing tank 9 or in rinsing chamber 3b, and in evaporator 10, and these heating devices are connected via electrical connection lines 33, 34, 35 and connection lines 36, 37, 38 to a central connection and distribution device 39 of generator 6. The connection and distribution device 39 also contains the electrical and/or electronic control device 7 of the plant, by means of which all components and process cycles of the combination plant can be monitored and controlled by means of sensors. The corresponding control lines are omitted for better clarity in the drawing. Heating devices 30, 31, 32 may be turned on, for example, in the start-up phase of the washing plant, in order to make the plant ready for operation as quickly as possible, but they may also be turned on or off or kept continually in operation as a function of the washing cycle and process-heat requirement.

Treatment chamber 3 according to FIG. 1 is equipped with sprinkling or spray nozzles 40, between which is disposed the support 4 that can be rotated by means of an electrical drive, in which the parts to be cleaned, which are not shown, are found, e.g., various small parts or large production pieces, such as engine parts. Washing fluid is sprinkled or sprayed, depending on the requirement, into treatment chamber 3 from washing-agent tank 8 via lines 44, 45, 46 by means of an electrical pump 47. After the washing cycle has terminated, the pump is turned off and valve 48 is closed. The used washing fluid is pumped out by pump 49 and introduced into a washing unit 50. The washing unit 50 may involve a filtering device. The refreshed fluid is introduced into washing-agent tank 8 again through line 52 by opening electrically actuatable valve 51. Used rinsing fluid can be introduced into washing unit 50 in a similar manner from rinsing-fluid tank 9 via line 53 and pump 54 and, in the example of embodiment, can be pumped into washing-agent tank 8 for freshening the washing fluid. Pumps 54 and 49 as well as valves 55 and 55a are controlled correspondingly. In the rinsing operation of plant 1, pump 47 is turned off and pump 56 is turned on. When valve 57 is opened, rinsing fluid from rinsing-fluid tank 9 is guided via line 58 through the sprinkling or spray nozzle 59 into treatment chamber 3. It should also still be mentioned that pure distillate from evaporator 10 reaches collecting tank 11 via line 60, and optionally, an intermediately connected condenser. From there, it is added to the rinsing fluid via line 61, valve 62 and pump 63. It should also be mentioned that evaporator 10 is supplied with used rinsing fluid via line 64.

Washing chamber 3a and rinsing chamber 3b according to FIG. 2 involve tub baths, which are filled with washing fluid and rinsing fluid. Rotatable or pivotable supports 4a for the goods to be washed are incorporated in washing chamber 3a and rinsing chamber 3b, and these supports are rotated or pivoted by means of an electrical motor (not shown) in the fluid bath. Used washing fluid or rinsing fluid from washing chamber 3a or rinsing chamber 3b can be guided through a washing unit 50 by means of line system 53a, valves 55b and 55c, as well as pump 49, and the refreshed fluid, in this case, can again be introduced into washing chamber 3a via line 52. Independently from this, the washing fluid in washing chamber 3a can be freshened with rinsing fluid from rinsing chamber 3b via line 53 (FIG. 2).

An air channel 41 is connected to treatment chamber 3 (FIG. 1) and drying chamber 3c (FIG. 2), and this channel blows heated drying air into treatment chamber 3 or drying chamber 3c from air heater 14. The electrical fan motor 42 is connected to connection and distribution device 39 via connection line 43. Alternatively, the drying process can be designed to operate in an inverse manner, i.e., in a suction or vacuum operation. A support 4a is also incorporated in drying chamber 3c for the goods to be washed, which is driven by electrical motor 65. Pump 63 is provided for filling chambers 3a, 3b with fresh water.

Several electrical connection lines of valves and pumps are not illustrated in detail in the drawing. It should be noted, however, that all electrical connection lines, which are not illustrated in detail, are guided into the connection and distribution device 39 of generator 6 and the corresponding electrical equipment is monitored, regulated and controlled via control device 7.

1. An industrial washing plant for washing objects that are dirtied with oily, greasy, or other processing residues and are treated with treatment media that require process heat for improving the treatment result, having at least one treatment chamber and a plurality of electrical/electronic installations for operating the plant, is hereby characterized in that a power/heat coupling plant with a cooling-fluid circuit is integrated into a process-heat circuit of washing plant, that the cooling-fluid circuit is coupled into the process-heat circuit for heating the treatment media, and the electrical power or current component of the power/heat coupling plant is used for the electrical/electronic installations during the operation of the plant, whereby, in order to take care of peak requirements, in particular in the start-up of the plant, the electrical power or current component of power/heat coupling plant for generation of process heat is supplied by electrical heating devices for heating the treatment media.

2. The washing plant according to claim 1, further characterized in that the requirements of washing plant for process heat and electricity are fine-tuned to the ratio between process heat that is generated and electrical power that is delivered by power/heat coupling plant.

3. The washing plant according to claim 1, further characterized in that the energy requirement of washing plant can be decoupled to up to approximately 70% as process heat and up to approximately 30% as electrical current or power from power/heat coupling plant.

4. The washing plant according to claim 1, further characterized in that the carrier of the process heat is conducted in a closed circuit of power/heat coupling plant and the process heat can be transferred to the treatment media of washing plant by means of heat exchangers.

5. The washing plant according to claim 1, further characterized in that an evaporator is provided, by means of which used washing fluid or rinsing fluid can be recovered by distillation, and process heat of power/heat coupling plant can be introduced into evaporator via heat exchanger for operating evaporator.

6. The washing plant according to claim 1, further characterized in that washing-agent tank and rinsing-agent tank are provided, in which are incorporated electrical heating units.

7. The washing plant according to claim 1, further characterized in that electrical heating units are incorporated in treatment chamber, washing chamber and rinsing chamber.

8. The washing plant according to claim 5, further characterized in that electrical current or power from power/heat coupling plant can be used for heating the evaporator fluid by means of an electrical heating device, for operating evaporator.

9. The washing plant according to claim 4, further characterized in that heat exchangers are incorporated in washing-agent tanks or rinsing-agent tanks.

10. The washing plant according to claim 4, further characterized in that heat exchangers are incorporated in air heaters.

11. The washing plant according to claim 4, further characterized in that heat exchangers are incorporated in treatment chamber, washing chamber and rinsing chamber.

12. The washing plant according to claim 1, further characterized in that power/heat coupling plant, as a block-type thermal power station, is equipped with a liquid-cooled internal combustion engine and a generator.

13. The washing plant according to claim 12, further characterized in that the cooling fluid of internal combustion engine serves as a washing fluid or a rinsing fluid.

14. The washing plant according to claim 12, further characterized in that the cooling circuit of internal combustion engine is conducted through the washing-agent tank or rinsing-agent tank.

15. The washing plant according to claim 13, further characterized in that the cooling circuit of internal combustion engine is conducted through treatment chamber, washing chamber and rinsing chamber.
